(19) United States
(12) Patent Application Publication
(10) Pub. No.: US 2016/0331099 A1
(43) Pub. Date: Nov. 17, 2016

(54) Retaining Apparatus

(71) Applicant: M. CRISCUOLO & CO., LIMITED, Kenley (GB)

(72) Inventors: Philip Michael Stanley, Birmingham (GB); David Edward Paul Criscuolo, Chaldon (GB)

(21) Appl. No.: 15/109,886

(22) PCT Filed: Feb. 2, 2015
(86) PCT No.: PCT/GB2015/000041

§ 371 Date: Jul. 6, 2016

(30) Foreign Application Priority Data
Feb. 6, 2014 (GB) 1402083.8

(51) Int. Cl. A45D 8/24; G09F 21/02; G09F 3/16; G09F 3/20; A45D 8/14; A45F 5/02

(52) U.S. Cl. CPC A45D 8/24; A45D 8/14; A45F 5/02; G09F 3/16; G09F 3/207; G09F 21/02

(57) ABSTRACT

Retaining apparatus (2) comprising: (i) first and second retaining elements (4, 6) extending adjacent one another; (ii) a hinge (8) connecting the first and second retaining elements (4, 6) at a hinge zone (10); and (iii) detent means (12) spaced from the hinge (8) and arranged to hold together the first and second retaining elements (4, 6); the retaining apparatus (2) being such that: (iv) the first retaining element (4) has an ability to be reorientable with respect to the second retaining element (6) between a first position of stability which is convex and a second position of stability which is concave; (v) the first retaining element (4) comprises a first part (14) and a second part (16); (vi) one of the first and second parts (14, 16) is shorter than the other of the first and second parts (14, 16) in order that the first retaining element (4) has the ability to be reorientable; and characterised in that: (vii) the shorter one of the first and second parts (14, 16) is crimped such that the crimping (18) causes the shortening.

This invention relates to retaining apparatus. The retaining apparatus may be, for example, a clip or a clasp for retaining hair in position, or a holder for a security pass or a name badge.

Our European Patent No. 0878144 discloses retaining apparatus comprising first and second retaining elements extending adjacent one another, a hinge connecting the first and second retaining elements at a hinge zone, and detent means spaced from the hinge and arranged to hold together the first and second retaining elements. The retaining apparatus is such that the first retaining element has an ability to be reorientable with respect to the second retaining element between a first position of stability with is convex, and a second position of stability which is concave. In one embodiment of the retaining apparatus disclosed in the European Patent, the first retaining element is stressed and bowed by the use of a rivet. The use of the rivet requires a separate manufacturing stage, which increases manufacturing costs. In addition, if the retaining apparatus is used for retaining hair, there may be occasions when hair become caught underneath the rivet.

It is an aim of the present invention to provide a construction which enables the use of a rivet to be optional.

Accordingly, one non-limiting embodiment of the present invention there is provided retaining apparatus comprising:
(i) first and second retaining elements extending adjacent one another;
(ii) a hinge connecting the first and second retaining elements at a hinge zone; and
(iii) detent means spaced from the hinge and arranged to hold together the first and second retaining elements;
   the retaining apparatus being such that:
(iv) the first retaining element has an ability to be reorientable with respect to the second retaining element between a first position of stability which is convex and a second position of stability which is concave;
(v) the first retaining element comprises a first part and a second part;
(vi) one of the first and second parts is shorter than the other of the first and second parts in order that the first retaining element has the ability to be reorientable; and
   characterised in that:
(vii) the shorter one of the first and second parts is crimped such that the crimping causes the shortening.

The retaining apparatus of the present invention is advantageous in that the crimping causes the shortening, and it is thus this crimping that gives the first retaining element its ability to be reorientable between the first position of stability which is convex and the second position of stability which is concave. The crimping avoids the need for using a rivet to cause shortening as occurs in the above mentioned European Patent. The crimping thus makes the use of the rivet optional. Preferably, the retaining apparatus of the present invention will be produced without a rivet but it may be produced with a rivet if one should be required, for example for an aesthetic effect.

The retaining apparatus of the present invention is preferably one in which the longer of the first and second parts is a non-crimped part, for example a plain part. However, if designs should so dictate, the longer of the first and second parts could be crimped, but crimped to a lesser degree than the other part so that the other part is the shortest part due to its greater degree of crimping. When the longer of the first and second parts is a non-crimped part, the retaining apparatus of the present invention will normally provide more than adequate grip for most use applications, especially since the crimping on the crimped part provides an increased surface area and therefore an increased degree of gripping of a product, for example hair. If extra increased grip should be required, then such extra increased grip may be afforded by crimping both the first and the second parts, with the part that is required to be the shorter part being crimped to a greater degree than the other part.

The retaining apparatus is preferably one in which the first part comprises at least one strip, in which the second part comprises at least two strips, and in which the strip of the first part is positioned between the two strips of the second part. Preferably, the retaining apparatus is one in which the first part is only one of the strips, and in which the second part is only two of the strips. In alternative constructions, the first part may have more than one of the strips, for example two of the strips, and the second part may have more than two of the strips, for example four of the strips. In further alternative constructions, the first part may simply be one strip and the second part may simply be one strip.

The retaining apparatus is preferably one in which the first and second retaining elements and the hinge are all formed from the same sheet of material. In this case, the first and second retaining elements and the hinge are also preferably formed as a one piece unit which does not have any additional parts holding the first and second retaining elements in their relative positions. Such a construction is especially advantageous over the disclosure in our above mentioned European Patent because a rivet need not be employed, which saves on a manufacturing step and also avoids possible snagging of hair on the rivet during use of the retaining apparatus as a hair clip or hair clasp.

The retaining apparatus may be one in which the hinge zone is a curved hinge zone comprising curved adjacent ends of the first and second parts.

The retaining apparatus may be one in which the detent means comprises a curved end of the first part.

The second retaining element may form a base for the retaining apparatus. The second retaining element may be plain, or embossed or otherwise decorated.

The second retaining element may be provided with a cover. The cover may be a decorative cover which is provided for the purpose of improving the aesthetic appearance of the retaining apparatus.

Preferably, the retaining apparatus is an elongate retaining apparatus. In this case, the crimping will normally extend transversely to the length of the elongate retaining apparatus and may be in the form of a series of steps. The retaining apparatus may be other than elongate retaining apparatus if desired.

The retaining apparatus may be made in any suitable and appropriate materials. Where a metal is employed, then steel may be used for mass production where cost considerations are important. Precious metals such for example as flexible gold may be employed where the retaining apparatus is to have a jewellery function in addition to a retaining function. Plastics materials may be employed. The retaining apparatus may be made by stamping when it is made of a metal, and by moulding or 3D printing when it is made of a plastics material.

Embodiments of the invention will now be described solely by way of example and with reference to the accompanying drawings in which:

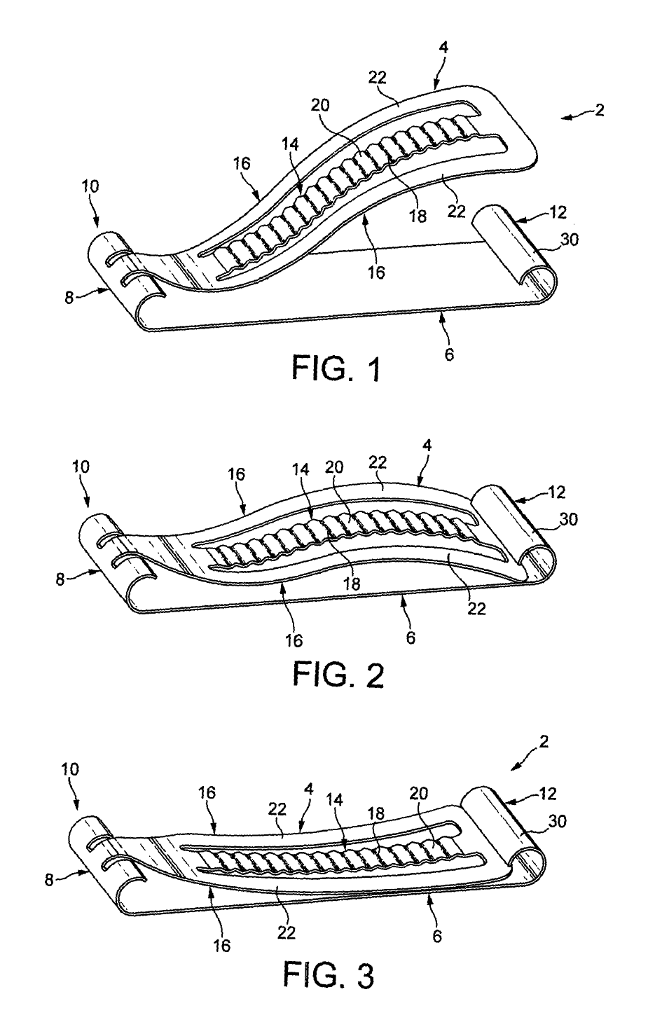

FIG. 1 is a perspective view of first retaining apparatus of the present invention with a first retaining element being in a first position of stability;

FIG. 2 is a view like FIG. 1 but shows the retaining apparatus with the first retaining element in an intermediate position between the first position of stability shown in FIG. 1 and a second position of stability;

FIG. 3 is a perspective view like FIG. 2 but shows the retaining apparatus with the first retaining element in the second position of stability;

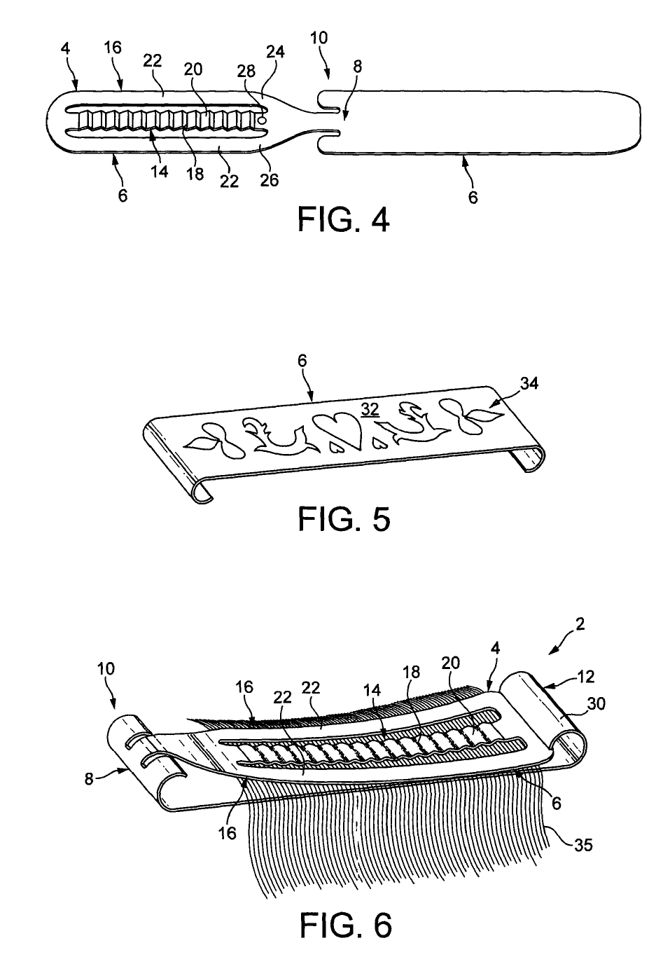

FIG. 4 is a top plan view showing the apparatus in template form;

FIG. 5 is an underneath view of the second retaining element as shown in FIG. 1, with the underneath view showing an optional design;

FIG. 6 shows retaining apparatus of the present invention in use in retaining hair in position and/or decoration;

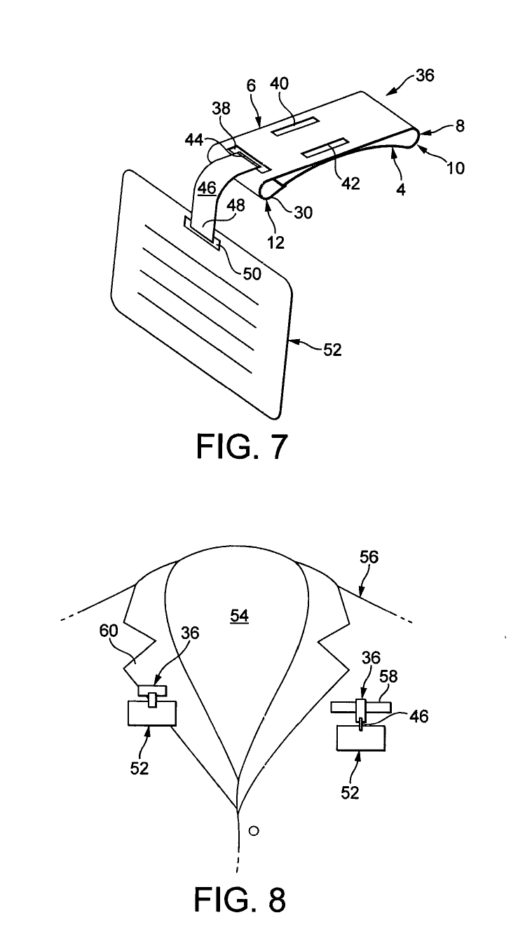

FIG. 7 is a perspective view of retaining apparatus of the present invention in use in holding a security pass; and

FIG. 8 shows how the security pass shown in FIG. 7 can be connected to the retaining apparatus at two different parts in order to give two different places of location on a person's jacket.

Referring to FIGS. 1-3, there is shown retaining apparatus 2 comprising a first retaining element 4 and a second retaining element 6. The first and second retaining elements 4, 6 extend adjacent one another as shown.

The retaining apparatus 2 further comprises a hinge 8. The hinge 8 connects the first and second retaining elements 4, 6 at a hinge zone 10. Detent means 12 is spaced apart from the hinge 8. The detent means 12 is arranged to hold together the first and second retaining elements 4, 6.

The retaining apparatus 2 is such that the first retaining element 4 has the ability to be reorientable with respect to the second retaining element 6 between a first position of stability which is convex and as shown in FIG. 1, and a second position of stability which is concave and which is shown in FIG. 3. FIG. 2 facilitates an understanding of how the first retaining element 4 goes from its first position of stability shown in FIG. 1 to its second position of stability shown in FIG. 3.

The retaining apparatus 2 is such that the first retaining element 4 comprises a first part 14 and a second part 16. One of the first and second parts 14, 16 is shorter than the other of the first and second parts 14, 16 in order that the first retaining element 4 has the ability to be reorientable. The shorter one of the first and second parts 14, 16 is crimped by crimping 18. It is the crimping 18 that causes the shortening.

As shown, the retaining apparatus 2 is such that the first part 14 comprises a single strip 20, and the second part 16 comprises two strips 22. The strip 20 of the first part 14 is positioned between the two strips 22 of the second part 16. The crimping 18 shortens the length of the strip 20. Shortening of the length of the strip 20 in turn tensions the strips 22 and causes them and the entire first part 14 to bow as shown.

In alternative embodiments (not shown), there could be most than one strip 20, for example two strips 20 arranged side by side. There could alternatively be more than two strips 22, for example four strips 22 arranged in two side-by-side pairs. Alternatively, there could one strip 20 and one strip 22. Other combinations for the strips 20 and 22 may be employed.

The two strips 22 shown in FIGS. 1-3 are non-crimped strips 22. Only the strip 20 has been crimped. In an alternative design (not shown), the strips 22 could also be crimped but then the strip 20 would require a greater degree of crimping than the strips 22 in order to ensure that the strip 20 was shorter than the strips 22 and thus caused the strips 22 to bow. The retaining apparatus 2 will usually provide a good retentive grip for products with just one of the parts 14, 16 being crimped. Crimping of both of the parts 14, 16 as mentioned above, i.e. with one part being crimped more than the other part in order to provide the required relative shortening between the first and second parts 14, 16, may be employed if extra grip is required.

As can best be appreciated from FIG. 4, the first and second retaining elements 4, 6 and the hinge 8 are all formed from the same sheet of material. The first and second retaining elements of 4, 6 and the hinge 8 are also formed as a one piece unit which does not have additional parts holding the first and second retaining elements 4, 6 in their relative positions. Such a one piece unit may be formed by metal stamping. In an alternative embodiment (not shown), the end portions 24, 26 may be cut free, crossed and riveted together at point 28 by a rivet. The cutting of the end portions 24, 26 and the riveting of these end portions together at the point 28 would not be necessary and would only be employed if required by a manufacturer, for example in cases where the rivet might be required for aesthetic reasons. Normally, since the crimping 18 provides the required relative shortening between the first and second parts 14, 16, the retaining apparatus 2 will preferably be made from the same sheet of material, as a one piece unit, and without the use of a rivet.

As can be appreciated from FIGS. 1-3, the hinge zone 10 is a curved hinge zone 10 comprising curved adjacent ends of the first and second parts 14, 16. The detent means 12 comprises a curved end 30 of the first part 6.

The second retaining element 6 forms a base for the retaining apparatus 2. The bottom face of the second retaining element 6 may be plain. Alternatively, as shown by way of example in FIG. 5, the bottom face 32 of the second retaining element 6 may be provided with a design 34. The design 34 may be any suitable and appropriate design.

In a further modification of the retaining apparatus (not shown), the second retaining element 6 may be provided with a cover. The cover may be a heat shrink cover or a clip-on cover. The cover may be employed to provide various decorative effects for aesthetic purposes.

The retaining apparatus 2 is an elongate retaining apparatus. The crimping 18 extends transversely of the length of the elongate retaining apparatus 2. The crimping 18 is in the form of a series of steps. In alternative designs, the retaining apparatus 2 may be other than elongate so that it may be, for example, square or circular.

The retaining apparatus 2 as shown in FIGS. 1-3 is easily manufactured. The crimping 18 firstly avoids the need for other means of relatively shortening the length of the first and second parts 14, 16, for example a rivet at the point 28. In FIGS. 4a, 4b and 4c of our above mentioned European Patent a rivet 3 is shown together with a first retaining element 2 which is formed by a first part having a single strip 15 and a second part having two strips 13, 14. It is to be noted that all of these first and second parts 15, 13, 14 are equally crimped by crimping 9 as shown in FIG. 4c. This crimping 9 operates with crimping 10 to provide the illustrated retaining apparatus with an increased grip facility. There is no teaching nor suggestion in our European Patent that the crimping 9 is used to provide the relative shortening between the first part formed by the strip 15 and the second part formed by the strips 13, 14. Indeed, this required shortening is not effected by the crimping, and is instead effected by the three ends of the strips 15, 13, 14 and the rivet 3 passing through the overlapping apertures 3a, 3b, 3c shown in FIG. 4a. The use of the crimping to provide the required relative shortening and make the use of the rivet 3 not essential, is something which was thought of after considerable and lengthy research and development.

FIG. 6 shows the retaining apparatus of FIG. 3 gripping and decorating a product in the form of a person's hair 35.

FIG. 7 shows retaining apparatus 36. Similar parts as in previous Figures have been given the same reference numerals for ease of comparison and understanding. It will be seen that the retaining apparatus 36 has a second retaining element 6 provided with a transverse slot 38 and two longitudinal slots 40, 42. In FIG. 7, the transverse slot 38 has received one end 44 of a plastics strip 46. The other end 48 of the plastics strip 46 is received in a slot 50 of a security pass 52. The two longitudinal slots 40, 42 are available for use one by a right handed person and the other by a left handed person, and in dependence upon if the retaining apparatus 36 is to be placed on a right or a left lapel or pocket.

FIG. 8 shows part of a persor 54 having a jacket 56. The jacket 56 has a top pocket 58. The security apparatus 36 in the embodiment shown in FIG. 7 is shown located in the top pocket 58.

FIG. 8 also shows an alternative method of locating the retaining apparatus 36. More specifically, on the left hand part of FIG. 8 as viewed, the retaining apparatus 36 is shown located on a lapel 60 of the jacket 56. To enable this location on the lapel 60, the end 44 of the strip 46 has been located in the slot 42.

It is to be appreciated that the embodiments of the invention described above with reference to the accompanying drawings have been given by way of example only and that modifications may be effected. Thus, for example, other types of crimping 18 to that shown may be employed. The shape of the first retaining element 4 and the second retaining element 6 may be different from those shown. Other formations for the hinge 8 and the detent means 12 may be employed. Individual components shown in the drawings are not limited to use in their drawings and they may be used in other drawings and in all aspects of the invention.

1. Retaining apparatus comprising:
(i) first and second retaining elements extending adjacent one another;
(ii) a hinge connecting the first and second retaining elements at a hinge zone; and
(iii) detent means spaced from the hinge and arranged to hold together the first and second retaining elements;
the retaining apparatus being such that:
(iv) the first retaining element has an ability to be reorientable with respect to the second retaining element between a first position of stability which is convex and a second position of stability which is concave;
(v) the first retaining element comprises a first part and a second part;
(vi) one of the first and second parts is shorter than the other of the first and second parts in order that the first retaining element has the ability to be reorientable; and
characterised in that:
(vii) the shorter one of the first and second parts is crimped such that the crimping causes the shortening.

2. Retaining apparatus according to claim 1 in which the longer of the first and second parts is a non-crimped part.

3. Retaining apparatus according to claim 1 in which the first part comprises at least one strip, in which the second part comprises at least two strips, and in which the strip of the first part is positioned between two strips of the second part.

4. Retaining apparatus according to claim 3 in which the first part has only one of the strips, and in which the second part has only two of the strips.

5. Retaining apparatus according to claim 1 in which the first part is the crimped part.

6. Retaining apparatus according to claim 1 in which the first and second retaining elements and the hinge are all formed from the same sheet of material.

7. Retaining apparatus according to claim 6 in which the first and second retaining elements and the hinge are also formed as a once piece unit which does not have additional parts holding the first and second retaining elements in their relative positions.

8. Retaining apparatus according to claim 1 in which the hinge zone is a curved hinge zone comprising curved adjacent ends of the first and second parts.

9. Retaining apparatus according to claim 1 in which the detent means comprises a curved end of the first part.

10. Retaining apparatus according to claim 1 in which the second retaining element forms a base for the retaining apparatus.

11. Retaining apparatus according to claim 1 in which the second retaining element is provided with a cover.

12. Retaining apparatus according to claim 11 in which the cover is a decorative cover.

13. Retaining apparatus according to claim 1 in which the retaining apparatus is an elongate retaining apparatus.
